(19) United States
(12) Patent Application Publication
(10) Pub. No.: US 2006/0236158 A1
(43) Pub. Date: Oct. 19, 2006

(54) Memory element for mitigating soft errors in logic

(76) Inventor: Larry J. Thayer, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/107,526

(22) Filed: Apr. 15, 2005

(51) Int. Cl. G06F 11/00

(52) U.S. Cl. 714/701

(57) ABSTRACT

In a preferred embodiment, the invention provides a method for reducing soft errors in logic. After obtaining two delayed data signals, the delayed data signals, the clock signal, and the data signal from a logic circuit are applied to a triple redundant memory element. The delay of the first delayed data signal is equal to or greater than the pulse width of a soft error event occurring in the logic circuit. The delay of the second delayed data signal is equal to or greater than half the pulse width of a soft error event occurring in the logic circuit.

### FIELD OF THE INVENTION

This invention relates generally to logic design. More particularly, this invention relates to improving soft error immunity in logic.

### BACKGROUND OF THE INVENTION

High-energy neutrons lose energy in materials mainly through collisions with silicon nuclei that lead to a chain of secondary reactions. These reactions deposit a dense track of electron-hole pairs as they pass through a p-n junction. Some of the deposited charge will recombine, and some will be collected at the junction contacts. When a particle strikes a sensitive region of a latch, the charge that accumulates could exceed the minimum charge that is needed to “flip” the value stored on the latch, resulting in a soft error.

The smallest charge that results in a soft error is called the critical charge of the latch. The rate at which soft errors occur (SER) is typically expressed in terms of failures in time (FIT).

A common source of soft errors are alpha particles which may be emitted by trace amounts of radioactive isotopes present in packing materials of integrated circuits. “Bump” material used in flip-chip packaging techniques has also been identified as a possible source of alpha particles.

Other sources of soft errors include high-energy cosmic rays and solar particles. High-energy cosmic rays and solar particles react with the upper atmosphere generating high-energy protons and neutrons that shower to the earth. Neutrons can be particularly troublesome as they can penetrate most man-made construction (some number of neutrons will pass through five feet of concrete). This effect varies with both latitude and altitude. In London, the effect is two times worse than on the equator. In Denver, Colo. with its mile-high altitude, the effect is three times worse than at sea-level San Francisco. In a commercial airplane, the effect can be 100-800 times worse than at sea-level.

Radiation induced soft errors are becoming one of the main contributors to failure rates in microprocessors and other complex ICs (integrated circuits). Several approaches have been suggested to reduce this type of failure. Adding ECC (Error Correction Code) or parity in data paths approaches this problem from an architectural level. Adding ECC or parity in data paths can be complex and costly. These approaches are not effective for reducing the SER in logic.

There is a need in the art to reduce the SER in logic. An embodiment of this invention reduces the SER in logic

### BRIEF DESCRIPTION OF THE DRAWINGS

FIG. 1 is a block diagram of a logic circuit and a triple redundant memory element. Prior Art

FIG. 2A is a block diagram of a logic circuit, two delay elements, and a triple redundant memory element.

FIG. 2B is a timing diagram showing the relative timing of the soft error event, CLK, delayed data signals, and the resulting logic.

FIG. 3 is a drawing of the pulse width of a soft error event.

FIG. 4 is a block diagram of a logic circuit, two delay elements, a triple redundant memory element.

FIG. 5 is a block diagram of a logic circuit, two delay elements, and a triple redundant memory element.

### DETAILED DESCRIPTION OF THE PREFERRED EMBODIMENT

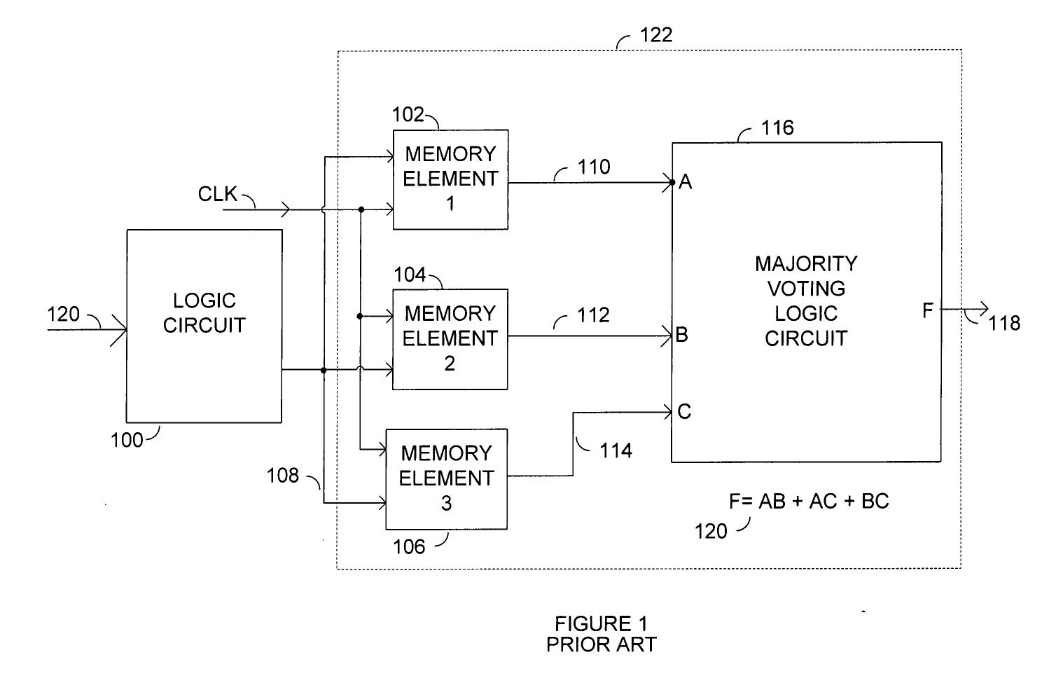

FIG. 1 is a block diagram of a logic circuit, 100, and a triple redundant memory element, 122. An input, 120, is connected to the input of logic circuit, 100. The output, 108, of the logic circuit, 100, is connected to the data input of memory element 1, 102, memory element 2, 104, and memory element, 106. Clock signal, CLK, controls when the signal on the input, 108, of memory element 1, 102, memory element 2, 104, and memory element 3, 106 is stored in memory element 1, 102, memory element 2, 104, and memory element 3, 106. The signal, 110, stored in memory element 1, 102, is presented at the input, A, of majority voting logic circuit, 116. The signal, 112, stored in memory element 2, 104, is presented at the input, B, of majority voting logic circuit, 116. The signal, 114, stored in memory element 3, 106, is presented at the input, C, of majority voting logic circuit, 116. A triple redundant memory element, 122, includes memory elements, 102, 104, 106, and majority voting logic circuit, 116.

The majority voting logic circuit, 116, contains the following Boolean logic:
F=AB+AC+BC
This logic assures that when two or more of the inputs (110, 112, or 114) are of the same logic value, that logic value is presented at the output, 118. As a result, if identical logic values are stored in memory elements 1, 2, and 3 (102, 104, and 106 respectively), and subsequently a soft error event changes one of the three memory elements (102, 104, or 106) to the opposite logic value, the original logic value stored in all three memory elements, (102, 104, and 106) will be maintained on the output, 118, of the majority voting logic circuit, 116. The circuit show in FIG. 1, however, does not correct soft errors occurring in the logic circuit, 100.

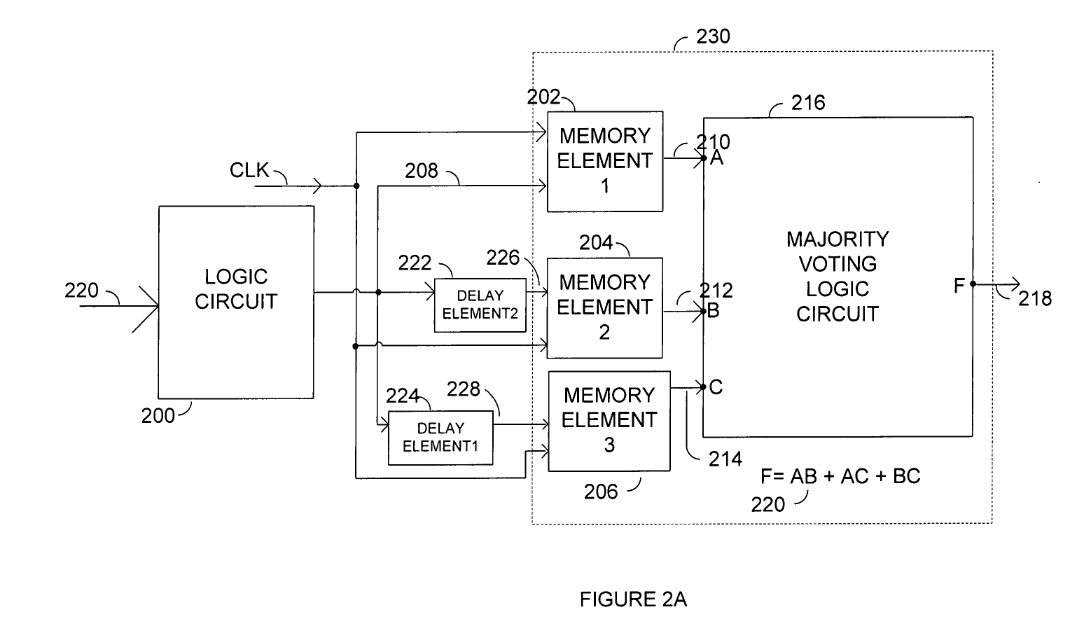

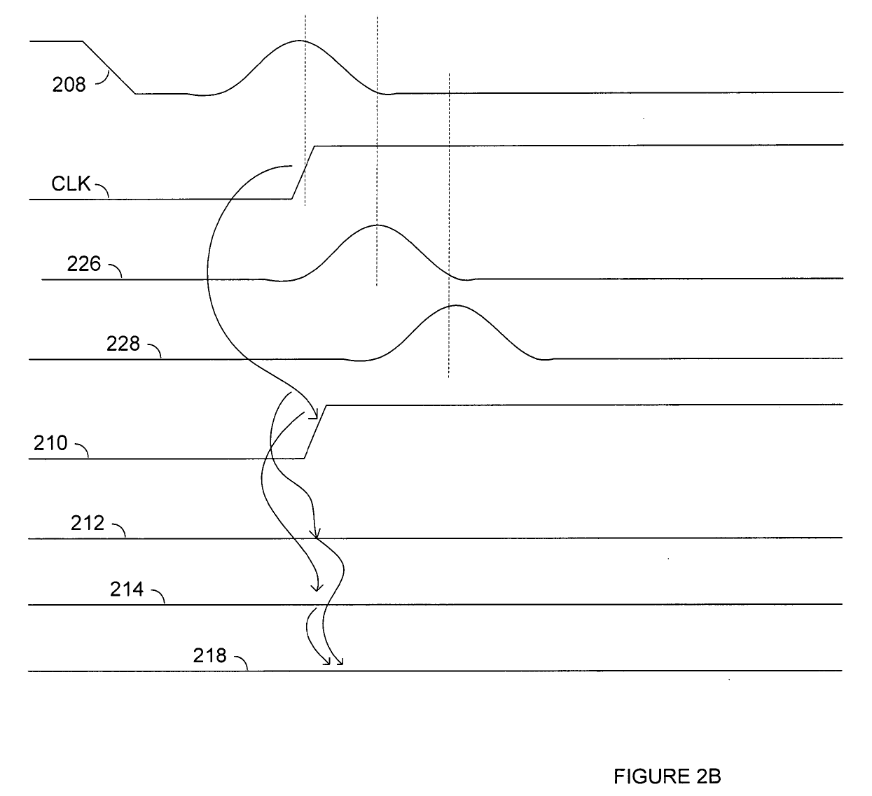

FIG. 2A is a block diagram of a logic circuit, 200, two delay elements, 222 and 224, and a triple redundant memory element, 230. An input, 220, is connected to the input of logic circuit, 200. The clock signal, CLK, is connected to the memory element 1, 202, memory element 2, 204, and memory element 3, 206. The data signal, 208, is connected to memory element 1, 202, delay element 2, 222, and delay element 1, 224. The output, 226, of delay element 2, 222, is connected to memory element 2, 204. The output, 228, of delay element 1, 224, is connected to memory element 3, 206. The signal, 210, stored in memory element 1, 202, is presented at the input, A, of majority voting logic circuit, 216. The signal, 212, stored in memory element 2, 204, is presented at the input, B, of majority voting logic circuit, 216. The signal, 214, stored in memory element 3, 206, is presented at the input, C, of majority voting logic circuit, 216. Delay elements 1 and 2, 222 and 224, may be implemented, for example, using a chain of inverters or a combination of resistors and capacitors in a pi-network. Memory elements 1, 2, and 3, 202, 204, and 206, may be implemented, for example, using a pulsed latch, an SRAM cell, a DRAM cell or a D-type flip-flop. A triple redundant memory element, 230, includes memory elements, 202, 204, 206, and majority voting logic circuit, 216.

The majority voting logic circuit, 216, contains the following Boolean logic:
F=AB+AC+BC
This logic assures that when two or more of the inputs (210, 212, or 214) are of the same logic value, that logic value is presented at the output, 218. As a result, if identical logic values are stored in memory elements 1, 2, and 3 (202, 204, and 206 respectively), and subsequently a soft error event changes one of the three memory elements (202, 204, or 206) to the opposite logic value, the original logic value stored in all three memory elements, (202, 204, and 206) will be maintained on the output, 218, of the majority voting logic circuit, 216. The circuit shown in FIG. 2 does correct soft errors occurring in the logic circuit, 200.

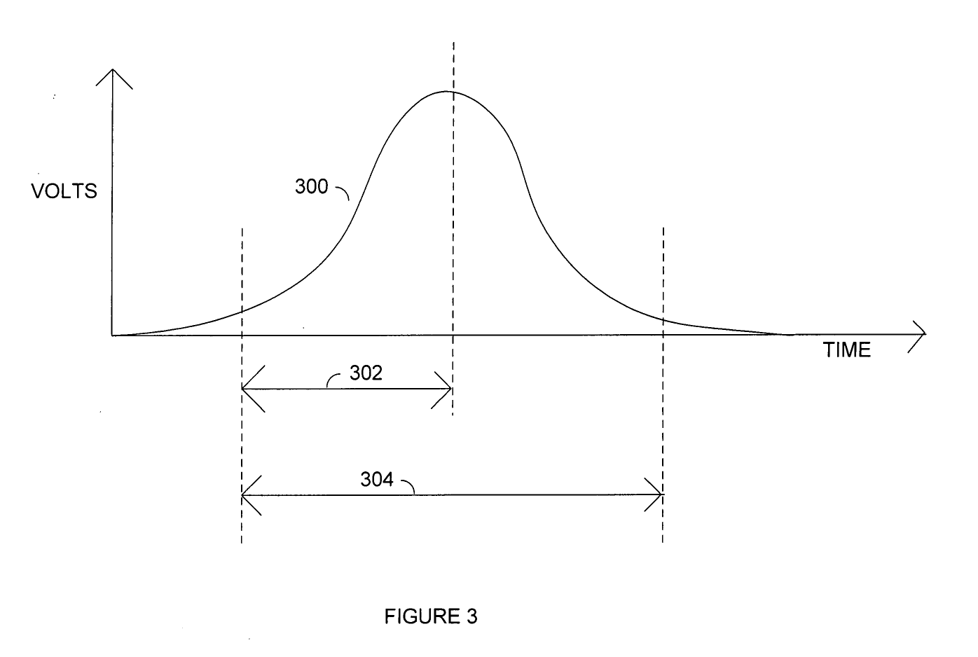

FIG. 3 is a drawing of the pulse width, 304, of a soft error event, 300. The time delay in delay elements 1 and 2 (224 and 222 respectively) are determined by the pulse width, 304, and the half pulse width, 302, respectively, shown in FIG. 3.

The time delay in delay element 1, 224, is equal to or greater than one pulse width of the soft error event, 304. The time delay in delay element 2, 222, is equal to one half or greater of the pulse width of the soft error event, 302. Because the data signal, 208, to memory elements 2 and 3 (204 and 206) is delayed by half the pulse width or greater, 302, and by the full pulse width or greater, 304, respectively, the data signal, 208, captured by memory elements 2 and 3 (204 and 206) is delayed by half the pulse width or greater, 302, and by the full pulse width or greater, 304, respectively. Creating these delays, 222 and 224, causes the original data signal, 208, created by the logic circuit, 200, to be stored in two of the three memory elements (202, 204, or 206) at all times during a soft error event, 300. Because two of the three memory elements (202, 204, or 206), during a soft error event, 300, contain the original logical value presented on data signal, 208, the majority voting logic circuit, 216, maintains the original logical value on data signal, 218.

For example, (see FIG. 2B for a timing diagram), if a soft error event, 300, changes the data signal, 208, from a logical zero to a logical one during the transition of the clock signal, CLK, a logical one will be stored in memory element 1, 202. Because the data signal, 208, is delayed by delay element 2, 222, memory element 2, 204, stores a logical zero during the transition of the clock signal, CLK. Because the data signal, 208, is delayed by delay element 1, 224, memory element 3, 206, stores a logical zero during the transition of the clock signal, CLK.

Because memory element 2, 204, contains a logical zero, 212 and memory element 3, 206, contains a logical zero, 214, after the soft error event, the majority voting logic circuit, 216, will create a logical zero at its output, 218. As a result, the original logical value, zero, produced by the logic circuit, 200, is maintained despite a soft error, 300, in the logic circuit, 200.

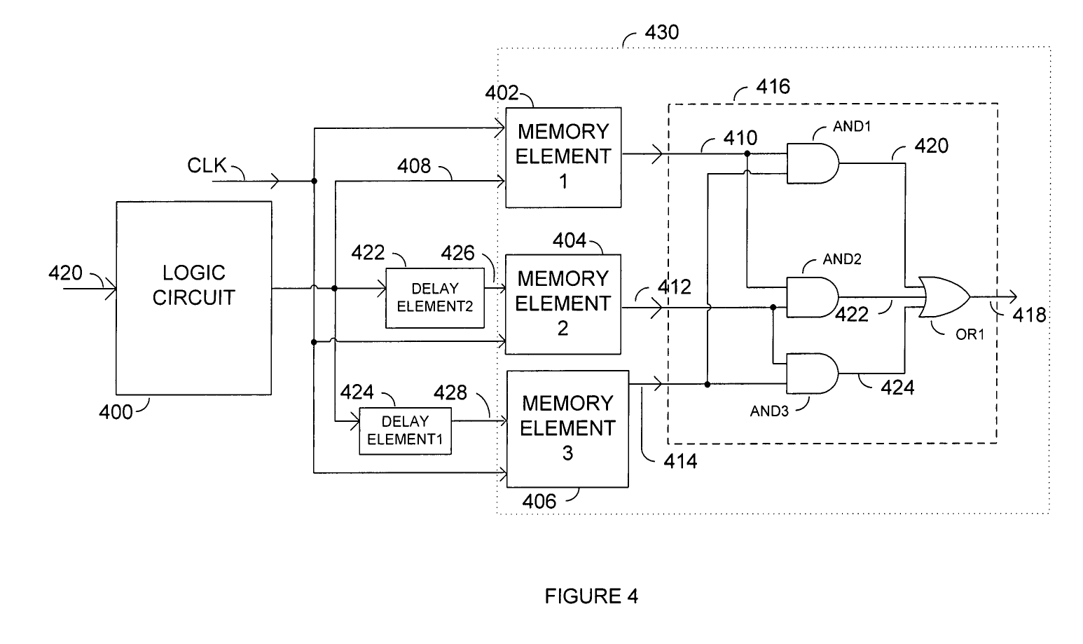

FIG. 4 is a block diagram of a logic circuit, 400, two delay elements, 422 and 424, and a triple redundant memory element, 430. In this embodiment of the invention, the majority voting logic circuit, 416, comprises three AND gates, AND1, AND2, and AND3, and an OR gate, OR1. An input, 420, is connected to the input of logic circuit, 400. The clock signal, CLK, is connected to an input of memory element 1, 402, memory element 2, 404, and memory element 3, 406. Data signal, 408, is connected to memory element 1, 402, delay element 2, 422, and delay element 1, 424. The output, 426, of delay element 2, 422, is connected to memory element 2, 404. The output, 428, of delay element 1, 424, is connected to memory element 3, 406. A triple redundant memory element, 430, includes memory elements, 402, 404, 406, and majority voting logic circuit, 416.

The signal, 410, stored in memory element 1, 402, is presented at an input of AND1 and an input of AND2, of majority voting logic circuit, 416. The signal, 412, stored in memory element 2, 404, is presented at an input of AND2 and an input of AND3, of majority voting logic circuit, 416. The signal, 414, stored in memory element 3, 406, is presented at an input of AND1 and an input of AND3, of majority voting logic circuit, 416. The output, 420, of AND gate, AND1, is connected to an input of OR gate, OR1. The output, 422, of AND gate, AND2, is connected to an input of OR gate, OR1. The output, 424, of AND gate, AND3, is connected to an input of OR gate, OR1. The output, 418, of OR gate, OR1, is connected to the output, 418, of the majority voting logic circuit, 416.

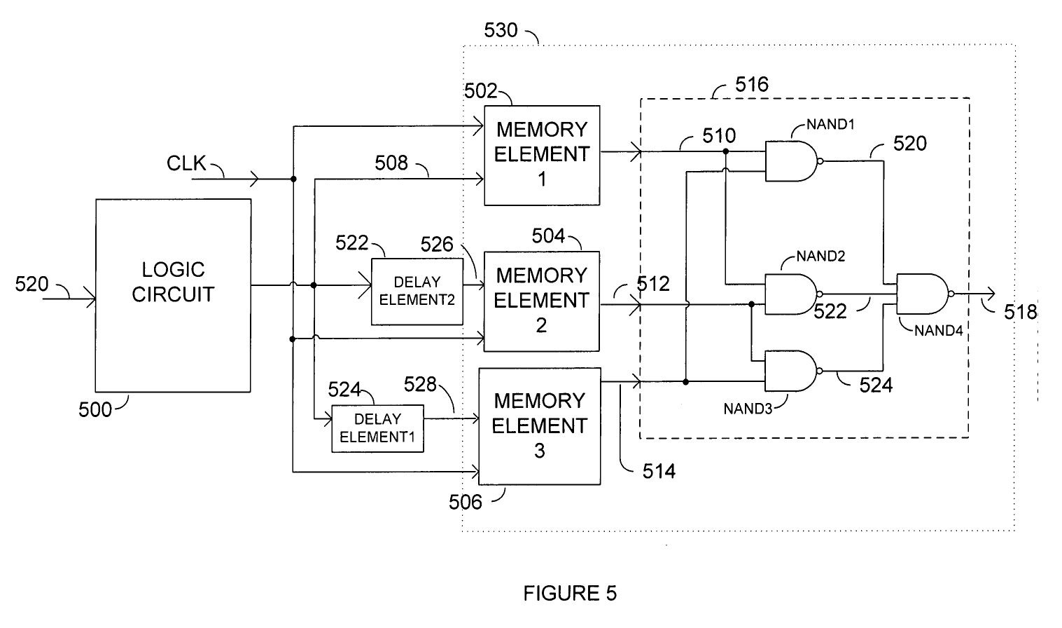

FIG. 5 is a block diagram of a logic circuit, 500, two delay elements, 522 and 524, a triple redundant memory element, 530. In this embodiment of the invention, the majority voting logic circuit, 516, comprises four NAND gates, NAND1, NAND2, NAND3 and NAND4. An input, 520, is connected to the input of logic circuit, 500. The clock signal, CLK, is connected to an input of memory element 1, 502, memory element 2, 504, and memory element 3, 506. Data signal, 508, is connected to memory element 1, 502, delay element 2, 522, and delay element 1, 524. The output, 526, of delay element 2, 522, is connected to memory element 2, 504. The output, 528, of delay element 1, 524, is connected to memory element 3, 506. A triple redundant memory element, 530, includes memory elements, 502, 504, 506, and majority voting logic circuit, 516.

The signal, 510, stored in memory element 1, 502, is presented at an input of NAND1 and an input of NAND2, of majority voting logic circuit, 516. The signal, 512, stored in memory element 2, 504, is presented at an input of NAND2 and an input of NAND3, of majority voting logic circuit, 516. The signal, 514, stored in memory element 3, 506, is presented at an input of NAND1 and an input of NAND3, of majority voting logic circuit, 516. The output, 520, of NAND gate, NAND1, is connected to an input of NAND gate, NAND4. The output, 522, of NAND gate, NAND2, is connected to an input of NAND gate, NAND4. The output, 524, of NAND gate, NAND3, is connected to an input of NAND gate, NAND4. The output, 518, of NAND gate, NAND4, is connected to the output, 518, of the majority voting logic circuit, 516.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1) A method for reducing soft errors in logic comprising:
a) obtaining a first delayed data signal;
b) obtaining a second delayed data signal;
c) applying a data signal from a logic circuit, the delayed data signals, and a clock signal to a triple redundant memory element;
d) such that the time delay of the first delayed data signal is equal to or greater than the pulse width of a soft error event occurring in the logic circuit;
e) such that the time delay of the second delayed data signal is equal to or greater than half the pulse width of a soft error event occurring in the logic circuit.

2) The method as in claim 1 wherein the delayed data signals are obtained by fabricating a chain of inverters in series.

3) The method as in claim 1 wherein the delayed data signals are obtained by fabricating one or more capacitors and one or more resistors in a pi-network.

4) The method as in claim 1 wherein the triple redundant memory element comprises:
a) three memory elements;
b) a majority voting logic circuit;
c) wherein an output from each memory element is connected to a separate input of the majority voting logic circuit;
d) wherein the clock signal is connected to all three memory elements;
e) wherein the data signal is connected to the first memory element;
f) wherein the first delayed data signal is connected to the third memory element;
g) wherein the second delayed data signal is connected to the second memory element.

5) The method as in claim 4 wherein the memory elements are DRAMs.

6) The method as in claim 4 wherein the memory elements are SRAMs.

7) The method as in claim 4 wherein the memory elements are D-type flip-flops.

8) The method as in claim 4 wherein the memory elements are pulsed latches.

9) The method as in claim 4 wherein the majority voting logic circuit comprises:
a) three two-input NANDs;
b) one three-input NAND;
c) wherein each output from the three two-input NANDs are connected to an input of the three-input NAND.

10) The method as in claim 4 wherein the majority voting logic circuit comprises:
a) three two-input ANDs;
b) one three-input OR;
c) wherein each output from the three two-input ANDs are connected to an input of the three-input OR.

11) A circuit for reducing soft errors in logic comprising:
a) a first delay element;
b) a second delay element;
c) a triple redundant memory element;
d) wherein a data signal from a logic circuit is applied to the first delay element, the second delay element, and to a triple redundant memory element;
e) wherein an output from the first delay element is connected to the triple redundant memory element;
f) wherein an output from the second delay element is connected to the triple redundant memory element;
g) wherein a clock signal is applied to the triple redundant memory element;
h) such that the time delay of the first delayed data signal is equal to or greater than the pulse width of a soft error event occurring in the logic circuit;
i) such that the time delay of the second delayed data signal is equal to or greater than half the pulse width of a soft error event occurring in the logic circuit.

12) The circuit as in claim 11 wherein the delay elements are a chain of inverters in series.

13) The circuit as in claim 11 wherein the delay elements are one or more capacitors and one or more resistors in a pi-network.

14) The circuit as in claim 11 wherein the triple redundant memory element comprises:
a) three memory elements;
b) a majority voting logic circuit;
c) wherein an output from each memory element is connected to a separate input of the majority voting logic circuit;
d) wherein the clock signal is connected to all three memory elements;
e) wherein the data signal is connected to the first memory element;
f) wherein the first delayed data signal is connected to the third memory element;
g) wherein the second delayed data signal is connected to the second memory element.

15) The circuit as in claim 14 wherein the memory elements are DRAMs.

16) The circuit as in claim 14 wherein the memory elements are SRAMs.

17) The circuit as in claim 14 wherein the memory elements are D-type flip-flops.

18) The circuit as in claim 14 wherein the memory elements are pulsed latches.

19) The circuit as in claim 14 wherein the majority voting logic circuit comprises:
a) three two-input NANDs;
b) one three-input NAND;
c) wherein each output from the three two-input NANDs are connected to an input of the three-input NAND.

20) The circuit as in claim 4 wherein the majority voting logic circuit comprises:
a) three two-input ANDs;
b) one three-input OR;
c) wherein each output from the three two-input ANDs are connected to an input of the three-input OR.

21) A circuit for reducing soft errors in logic comprising:
a) a first means for delaying a data signal;
b) a second means for delaying a data signal;
c) a means for storing a logical value in three distinct locations;
d) a means for outputting a same logical value as is present on two of the three inputs;
e) wherein a data signal is applied to the first means for delaying a data signal, the second means for delaying a data signal, and to a first location of the means for storing a logical value in three distinct locations;
f) wherein a clock signal is applied to the means for storing a logical value in three distinct locations;
g) such that the time delay through the first means for delaying a data signal is greater than the pulse width of a soft error event occurring in the logic circuit;
h) such that the time delay through the second means for delaying a data signal is greater than half the pulse width of a soft error event occurring in the logic circuit.
